(19) United States
(12) Patent Application Publication
(10) Pub. No.: US 2007/0022603 A1
(43) Pub. Date: Feb. 1, 2007

(54) Vapor chamber and manufacturing method thereof

(75) Inventors: Ming-Te Chuang, Taoyuan Hsien (TW); Chin-Ming Cheng, Taoyuan Hsien (TW); Chi-Feng Lin, Taoyuan Hsien (TW); Chin-Ming Chen, Taoyuan Hsien (TW)

Correspondence Address: BIRCH STEWART KOLASCH & BIRCH, PO BOX 747, FALLS CHURCH, VA, 22040-0747, US

(73) Assignee: DELTA ELECTRONICS INC.

(21) Appl. No.: 11/448,822

(22) Filed: Jun. 8, 2006

(30) Foreign Application Priority Data
Jul. 29, 2005 (TW) 94125806

(51) Int. Cl. B23P 6/00

(52) U.S. Cl. 29/890.032

(57) ABSTRACT

A vapor chamber applied to an electronic device generating heat is provided. The vapor chamber includes a hollow tube and a capillary structure, which is continuously formed on the inner surface of the hollow tube. The method for manufacturing the vapor chamber includes providing a hollow tube, forming the capillary structure on the inner surface of the hollow tube, filling a working fluid into the tube, and finally evacuating the hollow tube and sealing the other end of the tube, so as to provide better thermal transferring effect.

This non-provisional application claims priority under U.S.C.§ 119(A) on patent application No. 094125806, filed in Taiwan, Republic of China on Jul. 29, 2005, the entire contents of which are hereby incorporated by reference.

### BACKGROUND OF THE INVENTION

1. Field of the Invention

The invention relates in general to cooling apparatuses and in particular to a method for manufacturing vapor chambers.

2. Description of the Related Art

With progress in IC fabrication, while the number of transistors per unit area within an electronic component has greatly increased, more heat is generated during its operation. Heat pipes are widely used in heat dissipation of electronic devices because its simple structure and high efficiency. The heat pipes dissipate heat by using a working fluid continuously transferring between the liquid phase and the gas phase so as to carry heat away from the heat source.

Vapor chambers are a specific type of heat pipes, applying similar heat exchange to conventional heat pipes. Generally, as vapor chambers provide lager conductive surface and smaller dimensions than conventional heat pipes, they are suitable for compact electronic products having large heat dissipation surface. Various types of planar vapor chambers have been disclosed, and most of which use a top plate and a bottom plate to form a closed chamber, wherein capillary structures are formed on the inner surfaces of the plates. The capillary structures can be made by sintered powder, such as copper powder.

Referring to FIG. 1, a conventional vapor chamber 1 has a top plate 11 and a bottom plate 12. The top plate 11 and bottom plate 12 are combined by welding; and a welding area 13 is formed therebetween. A capillary structure 14, such as a wick, is formed on the inner surfaces of the top plate 11 and the bottom plate 12. Generally, to prevent solder overflow from the welding area 13 to the inner surfaces of the top plate 11 and bottom plate 12, a disconnection area 141 is provided between the inner surfaces the top plate 11 and the bottom plate 12. However, the disconnection area 141 adversely obstructs the thermal transmission pathway and reduces transferring effect of the vapor chamber.

As conventional vapor chambers are produced by welding two plates, the long welding path may reduce fabrication reliability and the capillary structures cannot be continuously formed on the inner surfaces of the two plates. As conventional welding fabrication requires many parts and complex molding technologies, production costs are potentially increased. Further, since the top and bottom plates must be produced individually with specific profiles, it is difficult to produce the two plates of different dimensions simultaneously during a single sintering process.

### BRIEF SUMMARY OF INVENTION

Thus, a method for manufacturing vapor chambers is provided, formed by copper extrusion or drawing. A capillary structure is formed on an inner surface of a hollow tube by sintering, wherein the capillary structure includes a metal spring, groove, pillar, mesh or metal powder porous structure.

Subsequently, an end of the hollow tube is sealed by welding, soldering, fusing or other mechanical process. A working fluid is filled into the hollow tube. The hollow tube is evacuated with the other end of the tube sealed.

According to the method for manufacturing a vapor chamber, the top and bottom plates can be integrally formed as a single piece, rather than using conventional welding method so as to avoid long welding path and improve reliability. Further, as continuous capillary structure facilitates movement of the working fluid, thermal transmission pathway is improved, as compared with the discontinuous capillary structure of conventional vapor chambers.

The method for manufacturing vapor chamber of the invention is suitable for single sintering process, wherein the dimension of the vapor chamber is adjustable by demand, thereby reducing mold cost and simplifying manufacturing processes. In summary, the method for manufacturing vapor chamber is cheap and flexible, producing various shapes of vapor chambers.

### BRIEF DESCRIPTION OF DRAWINGS

The invention can be more fully understood by reading the subsequent detailed description and examples with references made to the accompanying drawings, wherein:

FIG. 1 is a sectional view of a conventional vapor chamber;

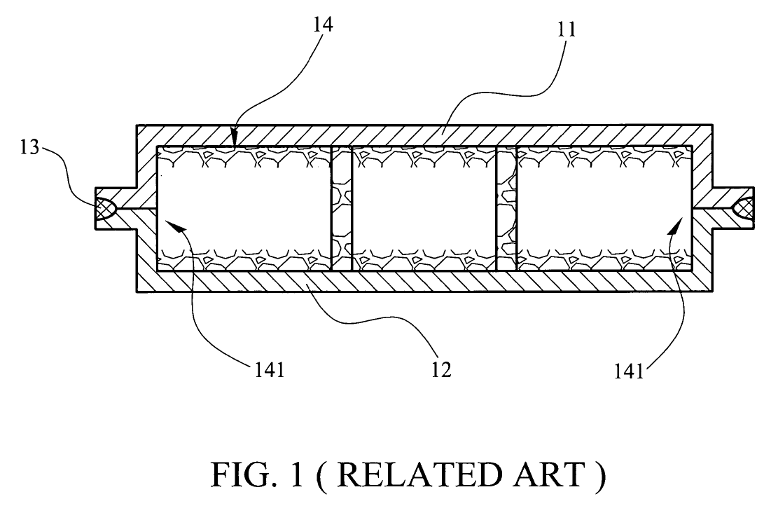

FIG. 2 is a sectional view of an embodiment of a vapor chamber manufactured according to the method of the invention; and

FIG. 3 is a sectional view of another embodiment of a vapor chamber manufactured according to the method of the invention.

### DETAILED DESCRIPTION OF INVENTION

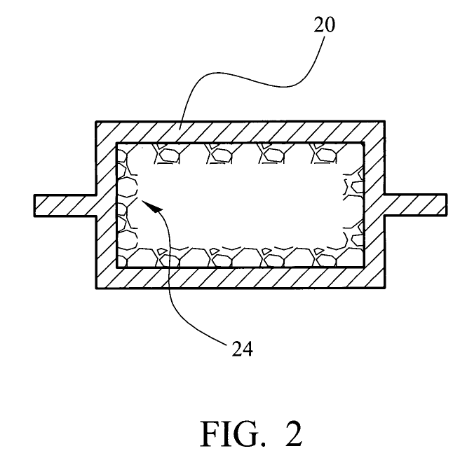

FIG. 2 is a sectional view of a first embodiment of a vapor chamber 2. The vapor chamber 2 includes a hollow tube 20 and a continuous capillary structure 24 disposed on the inner surface of the hollow tube 20.

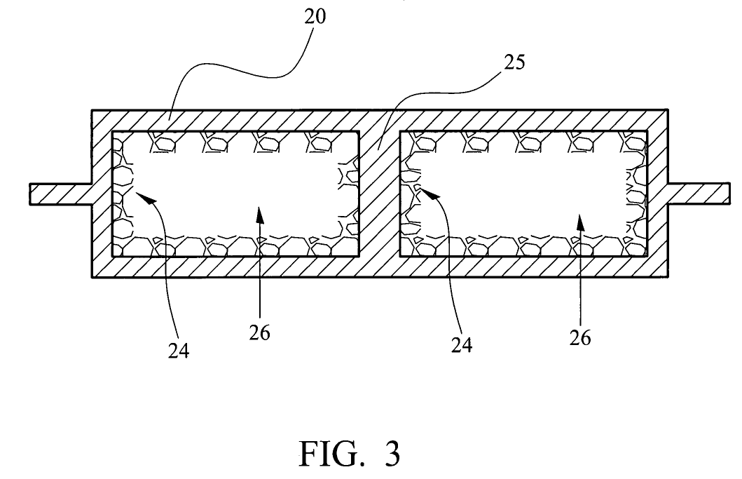

FIG. 3 is a sectional view of a second embodiment of a vapor chamber 3. Elements corresponding to those of FIGS. 2 and 3 share the same reference numerals, and explanation thereof is omitted for simplification of the description. Unlike FIG. 2, here, the hollow tube 20 is separated by a partition 25 into a plurality of closed rooms 26, and the capillary structure 24 is formed on the inner surfaces of the hollow tube 20 and the surface of the partition 25.

In a method for manufacturing vapor chambers, a hollow tube is integrally formed by copper extrusion or drawing. The hollow tube may be circular, elliptical, half-circular, rectangular, triangular, square, trapezoid, pentagonal, hexagonal, octagonal, equilateral or inequilateral in cross-section. The hollow tube is made of aluminum, copper, titanium, molybdenum, or a metal with a high thermal conductivity. Subsequently, a capillary structure is formed on the inner surface of the hollow tube and the surface of the partition 25 by sintering. Specifically, the capillary structure is formed by a porous spring, groove, pillar, mesh or metal powder porous structure.

One end of the hollow tube is sealed by welding, soldering, fusing or other mechanical process, and a working fluid is filled into the hollow tube. The working fluid is such as inorganic compounds, water, alkane, alcohol, liquid metal, ketone, Freon or organic compounds. After the working fluid is filled, the hollow tube is evacuated and completely sealed by sealing the other end of the hollow tube.

According to the method for manufacturing vapor chambers, the top and bottom plates can be integrally formed as a single piece, unlike conventional vapor chambers whose top and bottom plates are combined by welding. As the result, this avoids long welding path and improves reliability of the vapor chambers. Further, as continuous capillary structure facilitates movement of a working fluid, thermal transferring effect is improved over the discontinuous capillary structure of conventional vapor chambers.

Also, the method for manufacturing vapor chambers of the invention is suitable for single sintering process, wherein the dimensions of the vapor chamber are adjustable by demand, thereby reducing mold costs and simplifying manufacturing. In summary, the method for manufacturing vapor chamber is cheap and flexible to produce various shapes of vapor chambers.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation to encompass all such modifications and similar arrangements.

What is claimed is:

1. A method for manufacturing a vapor chamber, comprising:
providing a hollow tube and forming a capillary structure on an inner surface thereof;
sealing an end of the hollow tube and filling a working fluid thereinto; and
evacuating the hollow tube and sealing the other end of the hollow tube.

2. The method as claimed in claim 1, wherein the hollow tube is made of aluminum, copper, titanium, molybdenum, or a metal with a high thermal conductivity.

3. The method as claimed in claim 1, wherein the hollow tube is integrally formed by copper extrusion or drawing.

4. The method as claimed in claim 1, wherein the hollow tube is circular, elliptical, half-circular, rectangular, triangular, square, trapezoid, pentagonal, hexagonal, octagonal, equilateral or inequilateral in cross-section.

5. The method as claimed in claim 1, wherein the hollow tube comprises a partition separating the hollow tube into a plurality of closed rooms.

6. The method as claimed in claim 5, wherein the capillary structure is formed on a surface of the partition.

7. The method as claimed in claim 1, wherein the capillary structure is formed by sintering.

8. The method as claimed in claim 1, wherein the capillary structure comprises a metal spring, groove, pillar, mesh or metal powder porous structure.

9. The method as claimed in claim 1, wherein the hollow tube is sealed by welding, soldering, fusing or other mechanical process.

10. The method as claimed in claim 1, wherein the working fluid comprises inorganic compounds, water, alkane, alcohol, liquid metal, ketone, Freon or organic compounds.

11. A vapor chamber, comprising:
a hollow tube comprising a capillary structure continuously formed on an inner surface of the hollow tube, wherein both ends of the hollow tube are sealed and a working fluid is filled in the hollow tube.

12. The vapor chamber as claimed in claim 11, wherein the hollow tube is made of aluminum, copper, titanium, molybdenum, or a metal with a high thermal conductivity.

13. The vapor chamber as claimed in claim 11, wherein the hollow tube is integrally formed by copper extrusion or drawing.

14. The vapor chamber as claimed in claim 11, wherein the hollow tube is circular, elliptical, half-circular, rectangular, triangular, square, trapezoid, pentagonal, hexagonal, octagonal, equilateral or inequilateral in cross-section.

15. The vapor chamber as claimed in claim 11, wherein the hollow tube comprises a partition separating the hollow tube into a plurality of closed rooms.

16. The vapor chamber as claimed in claim 15, wherein the capillary structure is further formed on a surface of the partition.

17. The vapor chamber as claimed in claim 11, wherein the capillary structure is formed by sintering.

18. The vapor chamber as claimed in claim 11, wherein the capillary structure comprises a metal spring, groove, pillar, mesh or metal powder porous structure.

19. The vapor chamber as claimed in claim 11, wherein the hollow tube is sealed by welding, soldering, fusing or other mechanical process.

20. The vapor chamber as claimed in claim 11, wherein the working fluid comprises inorganic compounds, water, alkane, alcohol, liquid metal, ketone, Freon or organic compounds.
